(19) United States
(12) Patent Application Publication
(10) Pub. No.: US 2019/0202720 A1
(43) Pub. Date: Jul. 4, 2019

(54) Method for purifying food and meat processing facility liquids and process or waste waters by using a combination of metal salts and a flocculant to coagulate and then flocculate contaminants from a contaminated liquid

(71) Applicants: Jim Duffy, Defiance, MO (US); David Owen, Shropshire (GB); Andrew Kim, Troy, IL (US); Paul Juranek, St. Louis, MO (US); Phil McKenna, Ellisville, MO (US)

(72) Inventors: Jim Duffy, Defiance, MO (US); David Owen, Shropshire (GB); Andrew Kim, Troy, IL (US); Paul Juranek, St. Louis, MO (US); Phil McKenna, Ellisville, MO (US)

(73) Assignee: Fife Water Services, Inc., Ofallon, MO (US)

(21) Appl. No.: 15/858,551

(22) Filed: Dec. 29, 2017

(51) Int. Cl. C02F 1/52

(52) U.S. Cl. CPC C02F 1/5245; C02F 2103/32

(57) ABSTRACT

A method for purifying contaminated liquids, especially waste water with high TKN/BOD concentrations, by first introducing, into the contaminated liquid, an acidic coagulant such as a metal salt and then introducing a second alkaline coagulant, into the contaminated liquid which dramatically increases the speed and effectiveness of subsequent coagulation and flocculation and thereby removal of TKN/BOD. By comparing the total (molar amount of acidic coagulant cation+alkaline coagulant cation) with an equal molar amount of the acidic cation, superior removal of TKN/BOD are achieved due to a synergy between the acidic and alkaline coagulant versus using just an acidic metal coagulant.

The invention consists of a new method to markedly increase the effectiveness of the flocculation method of purifying process and waste waters with high levels of TKN/BOD which is especially suited for food and meat processing facilities.

One method of decontaminating or purifying contaminated liquids such as water is to place the contaminated liquid in a tank and introduce coagulation/flocculating chemicals such as aluminum chloride, aluminum sulfate, polyaluminum chlorides, ferric chloride, ferric sulfate, ferrous sulfate, ferrous chloride and then to vigorously agitate the liquid to allow the coagulant chemical to charge neutralize the contaminants. Next, in a separate tank a suitable flocculant is introduced and gently agitated to form a larger floc particle. The contaminated liquid, now somewhat decontaminated, is removed from the holding tank via gravity settling or floated to the surface. The water leaving the tank is substantially cleaner after the contaminants have been removed.

Before introducing the flocculating chemicals, contaminated water may have coagulants introduced which generally cancel the charge of the liquid contaminants and allow the contaminants themselves to begin to bind together.

Contaminants, colloids and chemicals generally, may coagulate slowly in water because the contaminants may have the same electrical charge. Like charges repel one another. Typically, these contaminant particles vary in size and the density of the charge on their surface. A good analogy is demonstrated by the negative poles of a magnet that push away from one another with a repulsive force.

The smaller the colloidal particle and the surface area, the more likely that these particles will stay in a state of suspension. This suspended state can be defined by turbidity (measured by the scattering of light) and/or filtration thru different pore sizes. Time, temperature, and the level of agitation are all parameters that determine how long the colloidal particles may stay in suspension.

In order to cause negatively charged contaminant particles to settle, a coagulant with a positive charge (cationic) is added to the water. When the correct dosage is achieved, the negative charges are cancelled on the particles surface allowing the particles to agglomerate or bind together. These substances may comprise of organic coagulants or metal coagulants such as salts iron and aluminum, that strongly dissociate in water to form positively charged metal ions and negatively charged hydroxyl ions. Under the proper lighting conditions the colloidal coagulation becomes a pin floc which is readily visible.

Flocculation is a process that speeds up the rate of settling of the now neutrally charged pin floc. In Industrial applications, this is important because it reduces the cost and time for these impurities to be removed. These now neutral contaminant particles are pulled together by flocculation into an agglomeration which increases the size and density of the particle. It typically involves the addition of a long chain polymer that is cationic, anionic or non-ionic in charge. A good analogy is a ball of twine with many pieces of twine extending in all directions. The twine extensions have Velcro-like properties that attach to the neutrally charge particles. The larger the particle, the faster the rate of settling. Stoke's Law provides a mathematical description of this process. As in coagulation, time, temperature, and the level of agitation are all parameters that determine how quickly a particle will settle.

The invention employs the use of coagulants, which may be inorganic and acidic metal based, in conjunction with an alkali metal based coagulant followed by the introduction of a very high molecular weight polyacrylamide flocculant of either cationic, neutral or anionic charge.

The acidic metal based coagulant may be a bi, tri or quad valent acidic metal salt. The acidic metal salt may be a salt of zirconium, aluminum, or iron including but not limited to zirconium oxychloride, aluminum sulfate, aluminum chloride, poly aluminumchloride, aluminumhydroxychloride, ferric chloride, ferric sulfate, ferrous chloride, ferrous sulfate or other acidic metal salt. The acidic metal salt is commonly zirconium oxychloride, aluminum sulfate, aluminum chloride, poly aluminumchloride, aluminumhydroxychloride, ferric chloride, ferric sulfate, terrous chloride, ferrous sulfate or other acidic metal salt.

The alkaline metal salt coagulant is commonly sodium aluminate.

The multiple coagulants (acidic metal salts plus basic metal salts) are introduced into the contaminated liquid and then the flocculant is introduced and flocculation occurs which removes most of the pollutants from the contaminated liquid.

The coagulation and flocculation is commonly done in a clarifier or a Dissolved Air Flotation Device (DAF) or other solid liquid separation device.

The acidic metal coagulants are typically ferric chloride or ferric sulfate. Additionally, acidic aluminum salt coagulants can be substituted for iron salt coagulants and would include (Aluminum sulfate or Aluminum chloride or Derivatives of poly aluminum chlorides). The order of addition can be reversed with no loss in removal efficiency of the above mentioned pollutants. The possible combinations in no particular order of addition are as follow (see FIG. 1):
1.) Iron salt coagulant (ferric chloride or ferric sulfate) and sodium aluminate
2.) Aluminum salt coagulant (aluminum sulfate or aluminum chloride or Derivatives of poly aluminum hydroxychloride) and sodium aluminate.

The claimed invention is that a normal coagulant such as an iron or aluminum salt, with or followed by sodium aluminate as an additional coagulant is much more effective at coagulation and subsequent flocculation, than an equal molar basis of any other combination found. The invention consists of a method of purification for contaminated liquids, including water, using two coagulants an acidic metal salt and a basic metal salt such as sodium aluminate. The coagulants are followed by a flocculant and a flocking process to separate out the contaminants.

The claimed invention has had superior results on the following pollutants, reducing them by greater than 85%.%: Biological Oxygen Demand (BOD), Total Kjehldahl Nitrogen (TKN), Total Suspended Solids (TSS), and Fats, Oils, and Grease (FOG).
The basic metal coagulant (sodium aluminate) when paired with an acidic metal salt coagulant provides superior performance than other metal, aluminum, iron, or zirconium based coagulants such as a bi, tri or quad valent material such as a salt of zirconium, aluminum, or iron including but not limited to zirconium oxychloride, aluminum sulfate, aluminumchloride, poly aluminumchloride, aluminumhydroxychloride, ferric chloride, ferric sulfate, ferrous chloride, ferrous sulfate or other acidic metal salt.
The best mode or preferred embodiment of the claimed invention is in purifying contaminated water from food and meat processing facilities. The contaminated water is placed in a holding tank or pool or floc tube The pH of the contaminated water ph is adjusted by the addition of an acidic metal salt(such as aluminum sulfate, ferric chloride or ferric sulfate among others). A soluble acid may also be used in conjunction with the acidic metal salt if the contaminated solution is excessively buffered. (such as caustic soda among others) or a soluble acid (such as hydrochloric or sulfuric acid among others) The optimum pH of the contaminated water is in the pH range of 3.5-6.5 (acidic) after the addition of the acidic coagulant and acid (if needed). In order to achieve the pH range of 3.5-6.5, the acidic metal salt is typically added to a concentration of 25-10,000 ppm. The contaminated water is agitated or mixed vigorously by mechanical means to insure proper charge neutralization by the coagulant.
   Depressing the pH in the range of 3.5-6.5 using an acidic metal salt and/or in conjunction with acid is a very important step for the following reason.
1.) Lowering the pH to the iso-electric point of soluble proteins causes them to precipitate out of solution and weakly attach to the partially soluble metal salt. Proteins and amino acids are major contributors to the TKN and the BOD of the contaminated water that need to be removed.
   After a minimum of 15-30 seconds the second coagulant, (such as sodium aluminate among other alkaline metal salts) is added to the contaminated water. The pH range after the addition of the alkaline metal salt is typically in the range of 6.0-9.0 and requires an addition rate of 25 to 10,000 parts per million to the contaminated water to achieve this desired pH range. Depending upon the amount of buffering in the contaminated water, a soluble alkaline source (such as sodium hydroxide amongst others) may need to be added in conjunction with the alkaline metal salt to achieve the pH range of 6.0-9.0. The contaminated water is agitated or mixed vigorously by mechanical means to insure proper charge neutralization by the coagulant.
   Raising the pH in the range of 6.0-9.0 using an alkaline metal salt and/or in conjunction with caustic or similar alkaline source is a very important step for the following reason.
1.) The alkaline metal salt adds hydroxyl alkalinity which causes the iron or aluminum salt initially added, to change from a partially soluble to nearly completely soluble phase.
2.) There is a synergy between the acidic and alkaline salts which is very effective in destabilizing the contaminants which contributed to TKN and BOD. The inventors to not have a scientific explanation for the synergy, but have empirically been observed this in many cases.
   After a minimum of 10-60 seconds the flocculant (either cationic, anionic or nonionic) are added to the contaminated water at an addition rate of10 to 1,000 parts per million in the contaminated water. The flocculation occurs for 10-60 seconds and then the partially decontaminated waste water is released from the floc tube, tank into a spot that allows extended settling time . Alternatively compressed air may be added allowing the contaminated material to float where it is skimmed leaving the contaminates removed from the water.

The invention is not limited to the structures, methods, and instrumentalities described herein and shown in the drawings. The invention is defined by the claims set forth in this application and subsequent patent.

### BRIEF DESCRIPTION OF DRAWINGS

While drawings are not required for a method patent such as this one:

FIG. 1 shows a flow chart of one embodiment of the invention described in the claims.

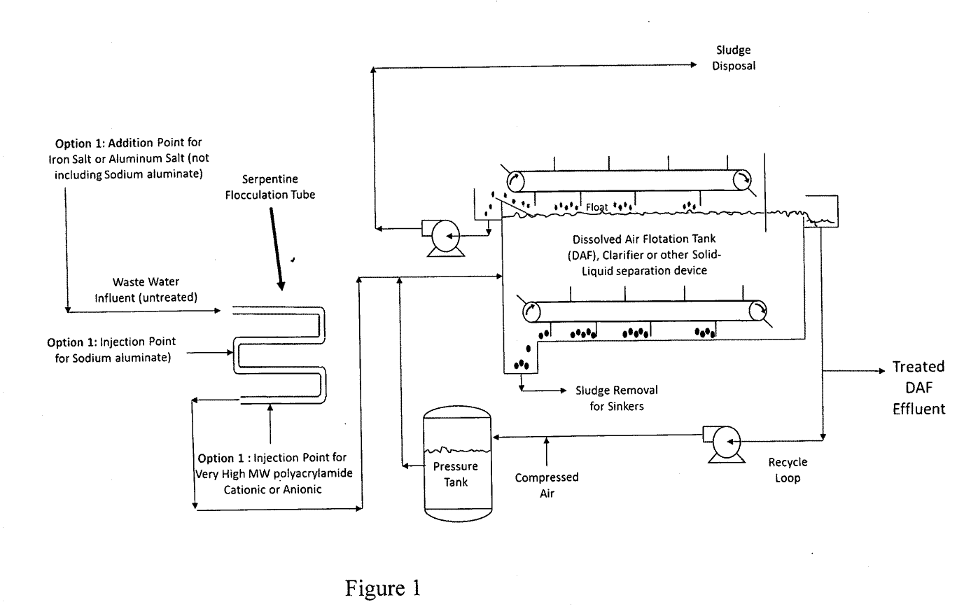

FIG. 2 shows a flow chart of one embodiment of the invention described in the claims.

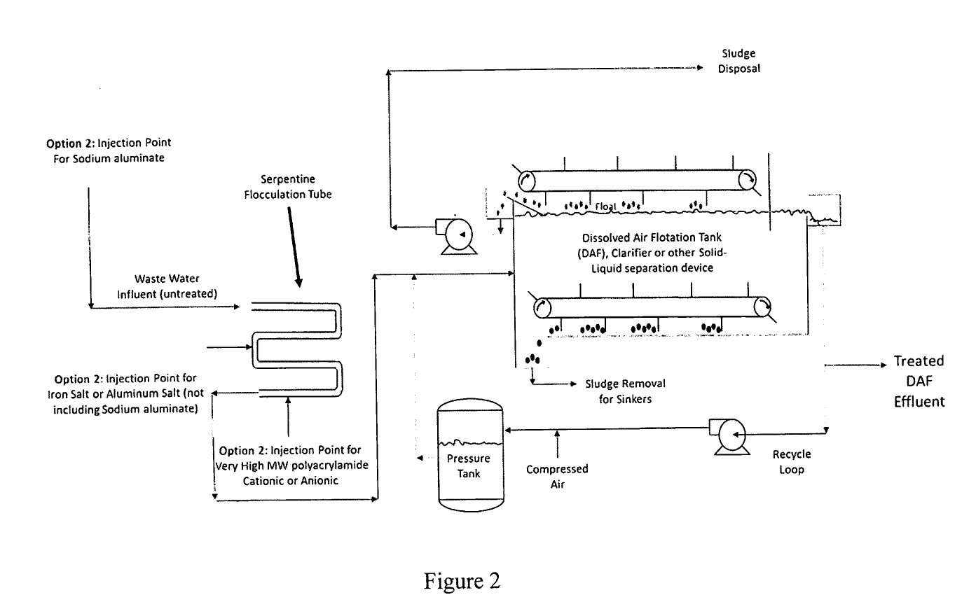

FIG. 3 shows a flow chart of one embodiment of the invention described in the claims.

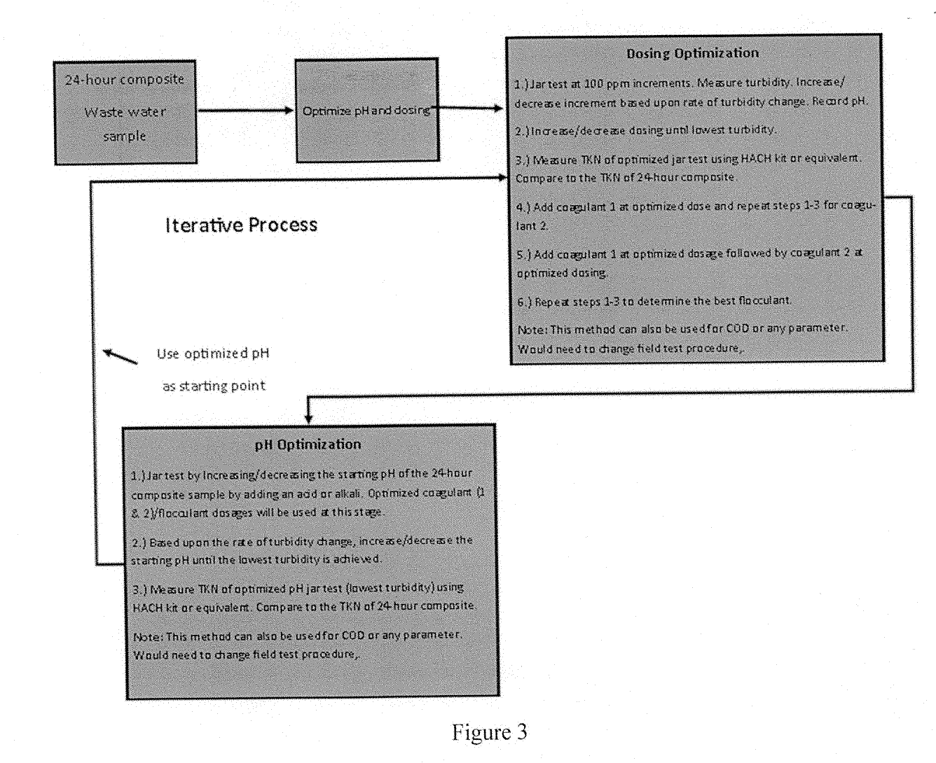

We claim:

1. A method for purifying a contaminated liquid, the method comprising promoting coagulation of the contaminants of the contaminated liquid by first adding to a contaminated liquid an acidic metal salt and second adding to a contaminated liquid an alkaline metal salt.

2. The method of purifying a contaminated liquid of claim 1, with the contaminated liquid being water.

3. The method of purifying a contaminated liquid of claim 2, further comprising a step of adjusting the pH of the contaminated liquid by adding an acid or a base before the addition of a metal salt to the contaminated liquid.

4. The method of purifying a contaminated liquid of claim 3, further comprising a step, following the addition of an alkaline metal salt to the contaminated liquid, to add a flocculant to the contaminated liquid.

5. The method of purifying a contaminated liquid of claim 4, further comprising a step, following the addition of a flocculant to the contaminated liquid, in which the contaminated liquid remains in a holding tank and the flocculated contaminants separate from the contaminated liquid in the holding tank.

6. The method of purifying a contaminated liquid of claim 5, further comprising a step, following the flocculated contaminants separating from the contaminated liquid in the holding tank of removing the contaminated liquid from the holding tank.

7. A method for purifying a contaminated liquid, the method comprising the steps of
adding both an acidic metal salt and an alkaline metal salt to the contaminated liquid;
adding a flocculant to the contaminated liquid;
allowing the contaminated liquid to remain in a holding tank;
allowing the contaminants in the contaminated liquid to floc and separate from the contaminated liquid in the holding tank; and
removing the contaminated liquid from the holding tank.

8. The method of purifying a contaminated liquid of claim 7, with the contaminated liquid being water.

9. The method of purifying a contaminated liquid of claim 8, with the acidic metal salt being a bi, tri or quad valent acidic metal salt.

10. The method of purifying a contaminated liquid of claim 8, with the alkaline metal salt being sodium aluminate.

11. The method of purifying a contaminated liquid of claim 9, with the acidic metal salt comprising a salt of zirconium, aluminum, or iron,

11. The method of purifying a contaminated liquid of claim 11, further comprising with the acidic metal salt comprising zirconium oxychloride, aluminum sulfate, aluminum chloride, poly aluminumchloride, aluminumhydroxychloride, ferric chloride, ferric sulfate, ferrous chloride, or ferrous sulfate.

12. A method of purifying a contaminated liquid by coagulation and flocculation, the method comprising the steps of:
Pre-conditioning the contaminated liquid by adjusting the pH of the contaminated liquid;
introducing an acidic metal salt into the contaminated liquid;
introducing a basic metal salt into the contaminated liquid;
introducing a flocculant into the contaminated liquid.

13. The method of claim 12, in which the contaminated liquid is water.

14. The method of claim 13, in which the metal salt is a bi, tri or quad valent acidic metal salt.

15. The method of claim 14, in which the acidic metal salt is introduced into the contaminated liquid to a concentration of 50 to 5000 parts per million.

16. The method of claim 15, in which the basic metal salt is introduced into the contaminated liquid to a concentration of 50 to 5000 parts per million.

17. The method of claim 16, in which the flocculant is introduced into the contaminated liquid to a concentration of 10 to 500 parts per million.

18. The method of claim 17, in which, after the introduction of the flocculant, the contaminated liquid is retained in a holding tank allowing the contaminants to flocculate and separate from the contaminated liquid in a holding tank.

19. The method of claim 18, in which, the contaminated liquid is removed from the holding tank after the flocculated contaminants have separated in the holding tank.

20. The method of claim 19, in which, the pH of the contaminated liquid is preconditioned by adjusting the pH of the contaminated liquid to a value of between 5.5 and 8.
